(19) United States
(12) Patent Application Publication
(10) Pub. No.: US 2004/0104808 A1
(43) Pub. Date: Jun. 3, 2004

(54) Method and system for displaying priority messages on a wireless device

(76) Inventor: Housh Khoshbin, Hawthorn Woods, IL (US)

Correspondence Address: James P. Muraff, Esq., WALLENSTEIN WAGNER & ROCKEY, LTD, 53rd Floor, 311 South Wacker Drive, Chicago, IL, 60606-6630, US

(21) Appl. No.: 10/661,090

(22) Filed: Sep. 12, 2003

Related U.S. Application Data
(63) Continuation-in-part of application No. 09/638,825, filed on Aug. 14, 2000.

(51) Int. Cl. H04Q 7/14

(52) U.S. Cl. 340/7.5; 340/7.53; 340/7.59; 340/7.55; 340/7.48

(57) ABSTRACT

The present disclosure provides a method for providing priority messages to a plurality of wireless devices for notifying respective users of the wireless devices of the priority message. The method comprising the steps of providing for receiving a priority message from an authority; providing for assigning a priority identifier to the priority message; and, providing for transmitting the priority message to the plurality of wireless devices. The priority identifier will cause the priority message to receive priority status once received by the plurality of the wireless devices.

### RELATED APPLICATION

This application is a Continuation-in-Part of U.S. Utility patent application Ser. No. 09/638,825, entitled “Method and Apparatus for Displaying Advertising Indicia on a Wireless Device,” filed Aug. 14, 2000. This application is incorporated herein by reference.

### TECHNICAL FIELD

The present invention generally relates to wireless devices for paging their users. More specifically, the present invention relates to a method and apparatus for displaying priority messages on a wireless device, such as a pager.

### BACKGROUND OF THE INVENTION

Wireless devices, such as pagers, have become common. These wireless devices have allowed individuals to communicate more efficiently in business and personal settings. Typical pagers include a display for displaying a message, such as a phone number to return a call. Typical pagers also include a receiver which “listens” for its particular signal to be broadcast from a base station. Once the pager's individual signal is broadcast, the receiver in the pager will recognize the signal has been sent and will indicate an alarm to the user of the pager. The pager will then display the message on the display.

One particular type of pager is disclosed in U.S. Pat. No. 5,999,088 issued to Sibbitt, entitled “Information Display Pager.” The Sibbitt pager provides a method and apparatus of providing active entertainment for persons waiting for service. Such persons are provided with an electronic pager assembly for notifying when service is available. The pager includes an electronically controllable pager assembly having a controllable screen display which is programmed with information likely to be desirable to a person holding the pager. A set of instructions enabling a person to access the information programmed in the pager assembly is printed on the assembly. The pager notification capability functions regardless of whether the information display is or is not active. The information is not automatically placed on the screen. Moreover, the user can choose to completely ignore the information within the pager and to wait until the pager “vibrates” as the notification that the user is ready to be seated in the restaurant.

Another particular type of pager is disclosed in U.S. Pat. No. 6,008,739, issued to Hymel, entitled “Increasing The Size Of Memory Available For Storing Messages In Response To The User Reading Advertisements In A Selective Call Receiver.” The Hymel patent is directed to a method of encouraging a user of an SCR (Selective Call Receiver) to read advertisements stored in the SCR. The user is provided with an initial level of access to a feature of the SCR that enhances the SCR's usefulness. When the user reads an advertisement, additional access to that feature is provided for a predetermined time period. Preferably, the feature is memory space, and each time the user reads an advertisement, the memory space available for storing messages is temporarily increased.

Another further particular type of pager is disclosed in U.S. Pat. No. 6,031,467, issued to Hymel et al., entitled “Method In a Selective Call Radio For Ensuring Reception Of Advertisement Messages.” The Hymel et al. patent discloses an SCR that receives personal messages and corresponding advertisement messages, and includes a receiver, memory, presentation circuit and processor. The processor is adapted to cause the receiver to receive a personal message, to determine whether a corresponding advertisement message has been previously stored in the memory, and in the event the corresponding advertisement message is not found, cause the presentation circuit to present the personal message to a user of the SCR. Additionally, the processor causes the presentation circuit to present a warning to the user that the SCR must receive the corresponding advertisement message within a predetermined time. If the corresponding advertisement message is not received within the predetermined time, the processor immediately disables the SCR. Thus, the advertisement messages can be lost when the pager is not on. Also, there is no provision for priority messages. In addition, a complicated structure is needed to ensure and encourage viewing of advertisement messages.

The present invention is provided to solve these and other problems.

### SUMMARY OF THE INVENTION

The present invention is a wireless device, such as a pager, that has an identity, such as a frequency and a plurality of network addresses. The wireless device is provided for notifying a user of a page, such as a telephone number, directed specifically to the identity of the wireless device. The wireless device includes a housing and a display attached to the housing. The wireless device further includes a driver connected to the display for causing indicia to appear on the display. The wireless device further includes a controller, such as a microprocessor connected to the driver for sending to the display a signal comprising indicia to appear on the display. The wireless device also has a memory preprogrammed with advertising indicia and a receiver connected to the controller for receiving a page signal directed specifically at the identity of the wireless device and for communicating the page signal to the controller. When the controller receives the page signal received by the receiver, the controller will then send to the driver a signal comprising the advertising indicia preprogrammed in the memory for causing the display to display the advertising indicia. The controller will then send to the driver a signal comprising an identification of the message for display on the display.

The display can be a liquid crystal display (LCD) and the memory can be an electrically erasable programmable read only memory (EEPROM). The advertising indicia can be a logo of a company, a company name, or other advertising indicia.

When the controller receives the page signal received by the receiver, the controller can then immediately send to the LCD driver a signal comprising the advertising indicia in the memory for causing the LCD to display the advertising indicia. The controller can then send to the LCD driver, within five seconds or less from the sending of the signal comprising the advertising indicia, a signal comprising the message.

In an additional embodiment of the present invention, the present invention is a memory device for a wireless device with its structure and functions generally as described. The memory device has a storage location preprogrammed with advertising indicia. When the controller receives the page signal received by the receiver, the controller will then send to the driver a signal comprising the advertising indicia preprogrammed in the memory for causing the display to display the advertising indicia, and the controller will then send to the driver a signal comprising an identification of the message for display on the display. In a further embodiment of the present invention, the present invention is a method of providing advertising indicia to a user of a wireless device on the display of the wireless device. The wireless device notifies the user of a page directed specifically to an identity of the wireless device. The method comprises the steps of receiving an advertising request for placement of advertising indicia within the wireless device; storing in a memory located within the wireless device the advertising indicia, before the user obtains permanent possession of the wireless device; providing permanent possession of the wireless device to the user; and, providing paging service to the user. The user receives the page signal. The advertising indicia stored in the memory of the wireless device then appear on the display of the wireless device. The message then appears on the display of the wireless device.

In an additional embodiment of the present invention, the present invention is a method for providing advertising indicia to a plurality of users of wireless devices on a display of the wireless device. The wireless device notifies a user of a page directed specifically to an identity of the wireless device. The method comprises the steps of providing a plurality of wireless devices to an advertiser that may want to advertise to the users of the wireless devices, wherein each wireless device has an identity; receiving a request from the advertiser for placement of advertising indicia on a sub-set of the plurality of users of wireless devices wherein the request for placement of advertising indicia comprises a demographic criteria for selecting the sub-set; determining the identities of the sub-set for placement of the advertising indicia wherein the identities of the sub-set have user demographic information corresponding to the demographic criteria received from the advertiser; and, providing paging service to the plurality of users, wherein the wireless devices of the sub-set receive the advertising indicia and the advertising indicia appears on the display of the wireless devices of the sub-set.

In an additional embodiment of the present invention, the present invention is a method for providing advertising indicia to a sender of a page to a user of a wireless device. The wireless device notifies the user of a page directed specifically to an identity of the wireless device. The method comprises the steps of providing a plurality of wireless devices to an advertiser that may want to advertise to a sender of a page to one of a plurality of users of the wireless devices wherein each wireless device has an identity; receiving a request from the advertiser for placement of an audible advertising message on a voice mail system; and, providing the audible advertising message to the sender of the page in response to the sender of the page requesting to leave a voice mail message directed specifically to the identity of the wireless device of the user.

In another embodiment of the present invention, there is provided a method for providing priority messages to a plurality of wireless devices for notifying respective users of the wireless devices of the priority message. The method comprising the steps of providing for receiving a priority message from an authority; providing for assigning a priority identifier to the priority message; and, providing for transmitting the priority message to the plurality of wireless devices. The priority identifier will cause the priority message to receive priority status once received by the plurality of the wireless devices. The method may further comprise the step of providing for displaying the priority message on the display of the plurality of wireless devices before any other message is displayed on the display of the plurality of wireless device. The priority identifier can be a network address. In addition, the method may further comprise the steps of: providing for assigning the priority message to a priority channel within the plurality of wireless devices; providing for displaying the priority message received on the priority channel of the plurality of wireless devices, on the display of the plurality of wireless devices immediately upon receipt by the plurality of wireless devices; and, providing for storing the priority message received on the priority channel of the plurality of wireless devices, in a priority state within the plurality of wireless devices.

The wireless devices may track whether a priority message has been displayed on the display of the wireless device. The method may also further comprise the step of providing for storing the priority message in a memory of the plurality of wireless devices for later retrieval, once the priority message has been displayed on the display of the plurality of wireless devices. The method may also further comprise the steps of: providing for automatically displaying the priority message upon any activity of a user interface of the plurality of wireless devices; providing for automatically displaying a graphic on the display of the plurality of wireless devices prior to displaying the priority message; and, providing for automatically displaying a graphic on the display of the plurality of wireless devices after displaying the priority message. The graphic may be an advertising logo, a sponsor message, or a text message. The method may further comprise the step of providing for distributing the plurality of wireless devices within a geographical area. The geographical area may be a nationwide area, a regional area, a local area, a rural area, a metropolitan area, or some other area. The method of receiving the priority message may comprise receiving the priority message from an “Amber Alert” system. The method may include a step of providing for receiving the priority message comprising the step of providing for receiving a graphic from an “Amber Alert” system. The priority message may comprise at least one of information regarding an abductee, information regarding an abductor, information regarding a vehicle, information regarding a time, information regarding a location.

The method may further comprise the steps of: providing for formatting the priority message for transmission to the plurality of wireless devices using information regarding an “Amber Alert”; and, providing for notifying respective users of the plurality of wireless devices of an “Amber Alert” priority message.

In another embodiment of the present invention, there is provided a system for providing priority messages to a plurality of wireless devices for notifying respective users of the wireless devices of the priority message. The system comprising means for receiving a priority message from an authority; means for assigning a priority identifier to the priority message; and, means for transmitting the priority message to the plurality of wireless devices, wherein the priority identifier will cause the priority message to receive priority status once received by the plurality of the wireless devices. The system may further comprise means for displaying the priority message on the display of the plurality of wireless devices before any other message is displayed on the display of the plurality of wireless device. The priority identifier may be a network address. The system may further comprise assigning the priority message to a priority channel within the plurality of wireless devices. The system may also further comprise: displaying the priority message received on the priority channel of the plurality of wireless devices, on the display of the plurality of wireless devices immediately upon receipt by the plurality of wireless devices; and, storing the priority message received on the priority channel of the plurality of wireless devices, in a priority state within the plurality of wireless devices. The system may have the wireless devices track whether a priority message has been displayed on the display of the wireless device. The system may further comprise storing the priority message in a memory of the plurality of wireless devices for later retrieval, once the priority message has been displayed on the display of the plurality of wireless devices. The system may have the authority comprise at least of one of a local law enforcement authority and an advertiser that has the authority to request the transmission of the priority message. The system may further comprise automatically displaying the priority message upon any activity of a user interface of the plurality of wireless devices. The system may also comprise automatically displaying a graphic on the display of the plurality of wireless devices prior to displaying the priority message. The system may also comprise automatically displaying a graphic on the display of the plurality of wireless devices after displaying the priority message. The graphic may be an advertising logo, a sponsor message or a text message. The system may further comprise distributing the plurality of wireless devices within a geographical area. The geographical area may comprise at least one of a nationwide area, a regional area, a local area, a rural area, and a metropolitan area. The system receives the priority message which may comprise receiving the priority message from an “Amber Alert” system. The system comprises receiving the priority message which may comprise receiving a graphic from an “Amber Alert” system. The priority message may comprise at least one of information regarding an abductee, information regarding an abductor, information regarding a vehicle, information regarding a time, information regarding a location. The system may further comprise formatting the priority message for transmission to the plurality of wireless devices using information regarding an “Amber Alert.” The system may also further comprise notifying respective users of the plurality of wireless devices of an “Amber Alert” priority message.

In another embodiment of the present invention, there is provided a wireless device for notifying a user of the wireless device of a priority message. The wireless device comprises a display for displaying a priority message originating from an authority and a receiver for receiving the priority message. The priority identifier is assigned to the priority message, and the priority identifier will cause the priority message to receive priority status once received by the wireless device. The wireless device may further comprise means for displaying the priority message on the display of the plurality of wireless devices before any other message is displayed on the display of the plurality of wireless device. The wireless device may also further comprise displaying the priority message received on the priority channel of the plurality of wireless devices, on the display of the plurality of wireless devices immediately upon receipt by the plurality of wireless devices. The wireless device may also further comprise of automatically displaying the priority message upon any activity of a user interface of the plurality of wireless devices.

Other features and advantages of the present invention will be apparent from the Figures, Detailed Description, and claims below. It is intended that all such additional systems, methods, features, and advantages be included within this description, be within the scope of the present invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is one embodiment of a wireless device of the present invention.

FIG. 2 is a block diagram of one embodiment of the process of implementing advertising indicia into the wireless device of the present invention.

FIG. 3A is an illustration of a main menu presenting a personal messages folder of the present invention.

FIG. 3B is an illustration of a plurality of individual messages stored in the personal messages folder of the present invention.

FIG. 3C is an illustration of a selected message stored in the personal messages folder of the present invention.

FIG. 4 is a memory allocation of one embodiment of the wireless device of the present invention.

FIG. 5 is a flow diagram of one embodiment of advertising indicia displayed on the display of the wireless device of the present invention.

FIG. 6A is an illustration of the main menu presenting the Maildrop messages folder of the present invention.

FIG. 6B is an illustration of a channel selection screen highlighting the Sports Channel stored in the Maildrop messages folder of the present invention.

FIG. 6C is an illustration of a channel selection screen highlighting the News Channel stored in the Maildrop messages folder of the present invention.

FIG. 6D is an illustration of a channel selection screen highlighting the Stocks Channel stored in the Maildrop messages folder of the present invention.

FIG. 6E is an illustration of a channel selection screen highlighting the Custom Channel stored in the Maildrop messages folder of the present invention.

FIG. 7A is an illustration of an individual Maildrop messages stored in the Maildrop messages folder of the present invention.

FIG. 7B is an illustration of the selected Maildrop message stored in the Maildrop messages folder of the present invention.

FIG. 8A is an illustration of the main menu presenting a Priority Message Channel of the present invention.

FIG. 8B is an illustration of an individual Priority Message stored in the Priority Message Channel of the present invention.

FIG. 8C is an illustration of a selected Priority Message stored in the Priority Message Channel of the present invention.

FIG. 8D is an illustration of the Priority Message Graphic of the present invention.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

System Hardware

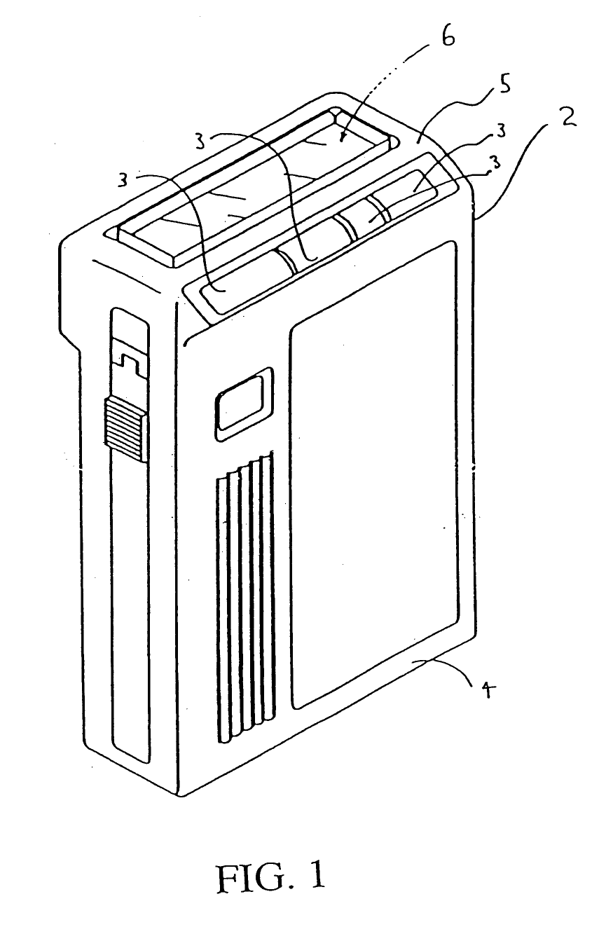

With reference to FIG. 1, one form of a wireless device, a pager 2, is shown. The pager 2 has an identity in the form of a frequency or small frequency range with which signals are sent to the pager 2, and which the pager 2 will recognize and respond to. The pager 2 is used for notifying a user of a page directed specifically to the pager 2. The page can be a person or a number to reach the person sending the page. The pager 2 has a housing 4 and a display 6 attached to the housing 4. The display 6 may be a liquid crystal display (LCD). The pager 2 includes a plurality of multi-function keys 3 for allowing the user to control operation of the pager 2, such as selecting a message to read or a folder to open. The multi-function keys 3 may be soft multi-function keys thereby allowing their functions can be changed or modified allowing different screens to utilize different functions for the same multi-function keys. The display 6 and the plurality of multi-function keys 3 create an interface 5 by which the user operates the pager 2.

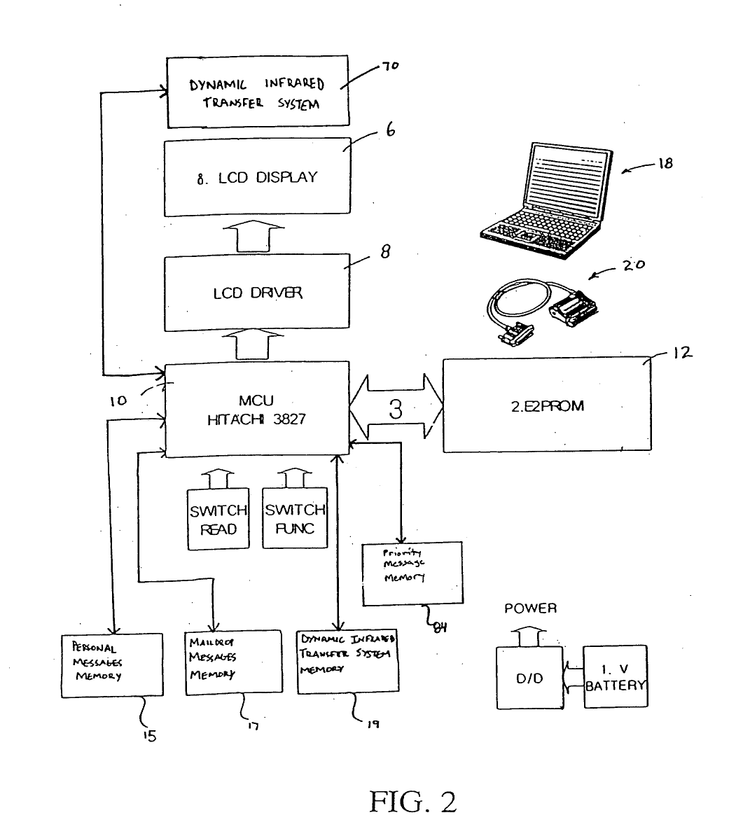

With further reference to FIG. 2, a display driver 8 is electrically connected to the display 6 for causing indicia to appear on the display 6. The display driver 8 may be a liquid crystal display driver. A controller or microprocessor 10 is connected to the display driver 8 for sending to the display 6 a signal that has indicia therein. In one form of the present invention, the controller 10 is an MCU Hitachi 3827 microprocessor. The controller 10 and the display driver 8 work together, as one of ordinary skill in the art would understand, to cause the indicia to appear on the display 6. The pager 2 also has an electrically erasable programmable read only memory (EEPROM) 12. The EEPROM 12 is preprogrammed with advertising indicia, as will be further described below. The preprogrammed advertising indicia therein can be changed, when the EEPROM 12 or other such changeable memory is used. The pager 2 has an audible and/or vibrating alarm for notifying the user when a page is taking place or has taken place. The pager 2 further comprises a power source for powering the controller 10, the display 6, and other components needing a power source. A receiver is electrically connected to the controller, as one of ordinary skill in the art would understand, for receiving a page signal directed specifically at the identity of the pager 2. The receiver will communicate the page signal to the controller 10 and the alarm for notifying the user of the page.

Receiving A Page

In one form of the present invention, when the controller 10 receives the page signal sent to the controller 10 by the receiver, after the receiver receives the signal, the controller 10 immediately sends to the display driver 8 a signal comprising the advertising indicia in the EEPROM 12 for causing the display 6 to display the advertising indicia. The advertising indicia can be the name of a company, a logo, or some other form of advertising indicia. Further, the advertising indicia may be a full motion graphic, such as a FLASH graphic. The controller 10 will then send to the display driver a signal comprising a message, such as a number or person's name, or both. Preferably, the signal comprising the message it sent to the display driver 8 within five seconds or less from the sending of the signal comprising the advertising indicia. In this way the user of the pager 2 does not have to wait an unnecessary amount of time, with the understanding that the user knows it has received the pager and the paging service for little or no charge.

In an even further embodiment of the present invention, the controller 10 can be programmed such that the advertising indicia 16 will appear on the display 6 for a selected length of time before the message is displayed on the display 6. As described above, the pager 2 has an audible and/or vibrating alarm for notifying a user when a page is taking place, or has taken place. The programmable time for the advertising indicia to be displayed in the display 6 can begin after the audible alarm is complete. Alternatively, the time that the advertising indicia are displayed on the display can begin about the same time as an alarm begins. These programmable features allow for flexibility in meeting the requests and demands of companies and individuals wishing to place advertising within a wireless device.

In another form of the invention, when the controller 10 receives the page signal received by the receiver, the pager 2 enters a NEW MESSAGE RECEIVED mode. In the case of the NEW MESSAGE RECEIVED mode, the user can wait to view the message until a later time after the alarm indicates the page has been received. The user can then press one of the multi-function keys 3 to select to view the message. When the user selects to do this, the advertising indicia will be displayed on the display 6 in the manner described above.

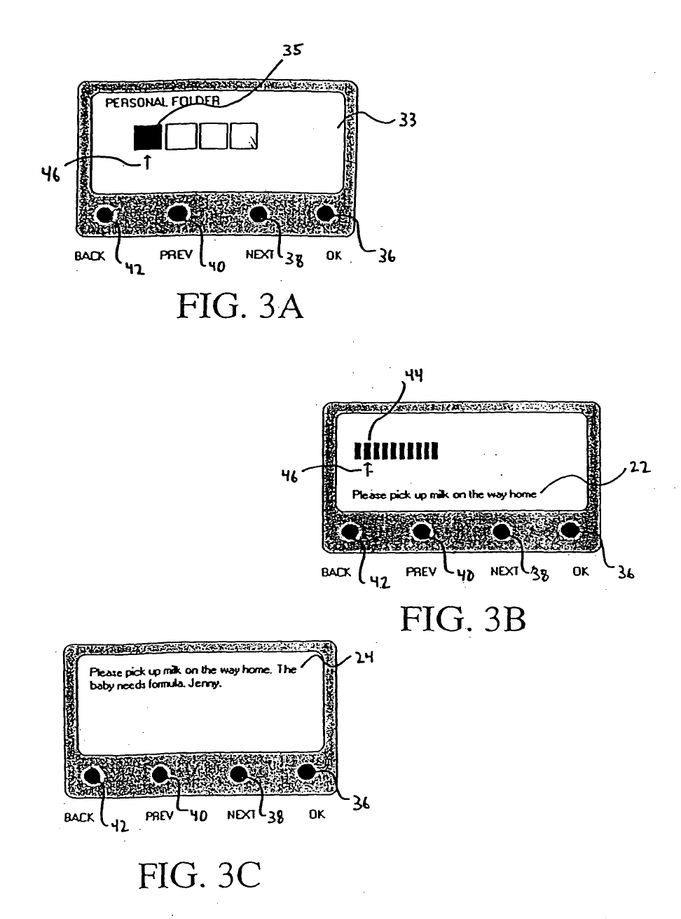

After the first viewing of the advertising indicia and associated message, the user can choose to keep the message in a personal messages memory 15 which is accessed via the interface 5 as the Personal Folder 35 from the Main Menu 33 as seen in FIG. 3A. In order to view a stored message, the user depresses a control button 3. In response, the pager 2 displays a screen as seen in FIG. 3A, allowing the user to access control functions relevant to the screen/function presented. Depressing the “OK” button 36 selects the Personal Message Memory section 15 and displays a new screen as seen in FIG. 3B. The display of FIG. 3B shows the individual messages stored in the Personal Message Memory section 15. Using the “NEXT” button 38 and the “PREV” button 40, the user can navigate the cursor 46 through the full range of indicators 44. To assist the user in selecting messages, the screen additionally displays, below the message indicators 46, a single text line 22 detailing the beginning of the relevant message indicated. This allows the user to glance at the first part of the message stored in the Personal Message Memory 15 and scroll from slot to slot to find a selected message of interest. Depressing the “OK” button 36 allows the user to display the selected message on the display 6, as seen in FIG. 3C.

FIG. 3C shows a selected message 24 stored in the personal messages memory 15 being displayed on the display 6 of the pager 2. Upon the selected message 24 being displayed, the functionality of the “NEXT” button 38 and “PREV” button 40 change so that depressing the NEXT button 38 moves the display screen forward so as to show subsequent screens of the message 24. When the end of the current message 24 is reached, a depression of the NEXT button 38 displays the first screen of the next message in that direction. Similarly, depressing the PREV button 40 moves the display screen backwards in the current message 24 until the beginning of the current message 24. When the beginning of the current message 24 is a reached, depressing PREV button 40 will display the first screen of the message in the previous direction. Depressing the BACK button 42 moves the user up a level in the menu system as seen in FIG. 3B thus allowing the user to move through the full range of indicators 44 and selecting individual messages to be viewed. It should be noted the “OK” button 36, “NEXT” button 38, “PREV” button 40, and “BACK” button 42 may be arranged in any manner.

Storing the Advertising Indicia in Memory

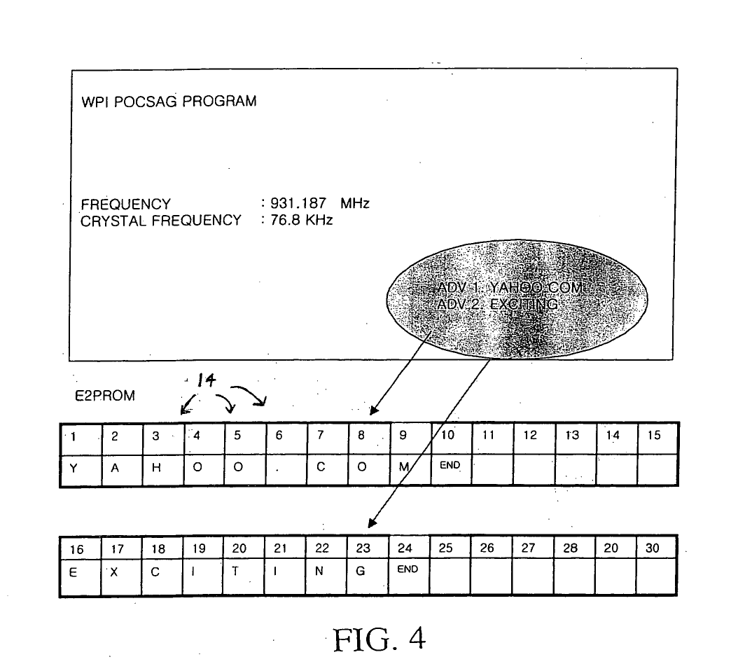

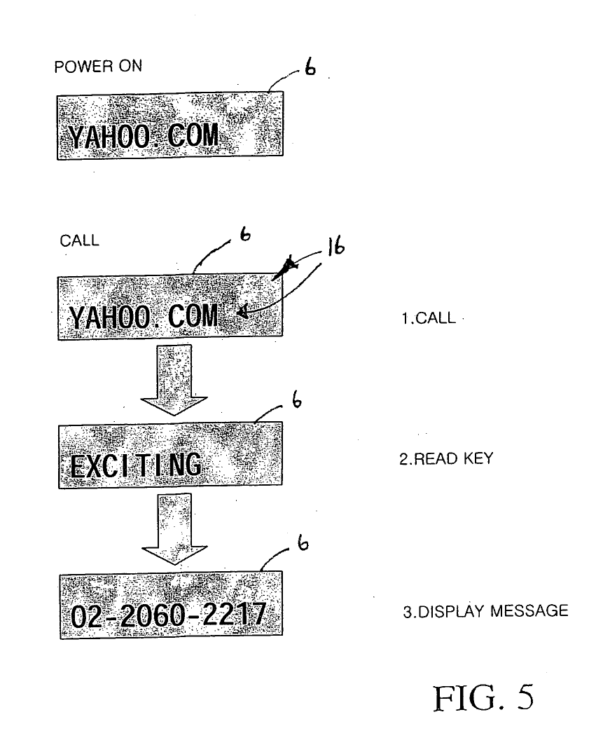

In the embodiment shown in FIG. 4-FIG. 5, the memory device has several storage locations 14, at least one of which is preprogrammed with advertising indicia. FIG. 4 depicts the company name “YAHOO.COM” (see FIG. 5) pre-programmed in the storage location 14. It should be noted that the advertising indicia may be of a non-commercial manner. As described above, when the controller 10 receives the page signal received by the receiver, the controller 10 sends to the driver 8 a signal comprising the advertising indicia preprogrammed in the memory 12 for causing the display 6 to display the advertising indicia. Thereafter, the controller 10 will send to the driver 8 a signal comprising the message for display on the display 6. As will be described further below, the advertising indicia is preprogrammed, at either the factory or assembly facility where the pager 2 is manufactured, or where the pager 2 is distributed, such as a wholesaler or retailer. In one embodiment of the present invention, the sellers of the pager devices, in order to make the price more reasonable for the user, if at any price at all, contract directly with a company or person wishing to advertise a product, name, service, or other thing representable through indicia. The seller can, thus, receive a request for placement of advertising indicia within the wireless device 2. The seller or other entity will then store in the memory 12 of the wireless device 2 the advertising indicia. This is done before the user obtains permanent possession of the wireless device, although it can be done after the user has identified in a store or otherwise, which pager 2 the user is interested in using and receiving on a permanent basis. Once the seller has programmed the advertising indicia 16 within the pager 2, the seller provides the wireless device to the user on a permanent basis. This can be done on a no-charge basis. The paging service will then be provided to the user such that when the user receives the page from the source, the advertising indicia 16 stored in the memory 12 of the wireless device 2 will appear on the display 6, in the manner described above.

As mentioned above, the seller of the pager 2 can program the advertising indicia 16 into the pager 2. This can be accomplished by connecting a personal computer 18 to the wireless device 2. This connection may be remote or local and through, for example, an RF connection. Other remote/local means can be used as well. One example of a local means can be a cable 20. The cable 20 can connect through a serial port in the personal computer 18 at one end of the cable 20 and to an EEPROM programming board, having an EEPROM 12 thereon, at the other end of the cable 20. Software is then run on the personal computer 18 that allows for communication between the personal computer 18 and the EEPROM 12 that is then placed in the wireless device 2. Alternatively, the other end of the cable 20 can be directly connected to the wireless device 2. The seller then enters the advertising indicia 16 into the software running on the personal computer 18, and the advertising indicia 16 is then sent to the wireless device 12 from the personal computer 18 for storage in the memory 12, either directly or indirectly through the use of the EEPROM programming board. The connection between the personal computer 18 and the wireless device is then disconnected, either directly or indirectly from the EEPROM programming board.

The advertiser 34 can pay for some or all of the wireless device or associated paging service, if needed. Several different advertising indicia can be preprogrammed into memory before the user receives permanent possession thereof. In a further embodiment of the present invention, when a first page is received, a first advertising indicia, such as “YAHOO.COM” stored in memory 12 can be displayed on the display 6 of the wireless device 2. When a second page is received, a second advertising indicia, such as “COKE” stored in memory 12 can be displayed on the display 6 of the wireless device 2. When more than one advertising indicia are preprogrammed into memory 12, the advertising indicia can alternate being displayed on the display 6. In an even further embodiment, the controller 10 of the wireless device 2 can be programmed to cause the first advertising indicia to appear on the display a particular percentage of the time of the overall number of pages for a given time period. For example if YAHOO and COKE placed advertising requests, and YAHOO paid more than COKE, then the wireless device 2 could be programmed to have a cycle with four slots, and YAHOO would take up three of the four slots, with COKE taking up the fourth slot. Thus, YAHOO would appear three times in a row, for the first three pages, and COKE would come up on the fourth page. This cycle can be repeated. Other numbers of slots in one cycle could also be used. Other programming methods come to mind of one of ordinary skill in the art, so long as the proper percentage of appearances is achieved.

Maildrop Function/Private Channel

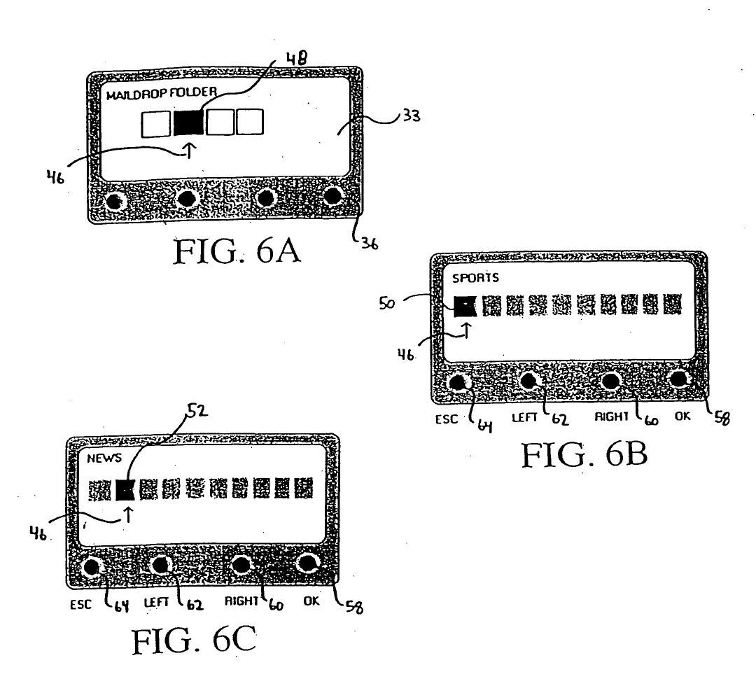

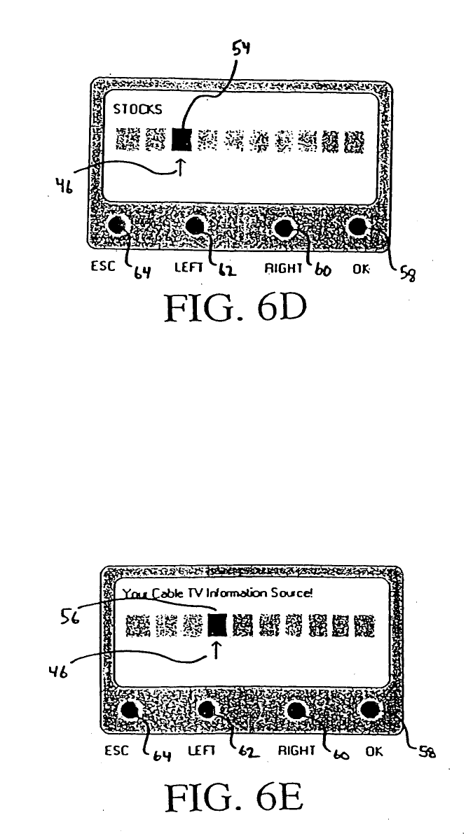

The pager 2 further includes a plurality of channels such as the Maildrop Message Channel, Coupon Channel, Payment Channel, and the Priority Message Channel. The Maildrop Message Channel presents advertising messages, rather than personal text messages as described above. The advertising messages are stored in a Maildrop messages memory 17 and are accessed via the interface 5 as the Maildrop Folder 48 as seen in FIG. 6A. Selecting the Maildrop Folder 48 opens a new menu screen presenting a plurality of selected Maildrop Message Channels thereof as seen in FIG. 6B-FIG. 6E. The plurality of Maildrop Message Channels may include a Sports Channel 50, a News Channel 52, a Stocks Channel 54, and other Custom channels 56, such as Cable TV Information Source. In addition, the Maildrop Message Channel may include the Priority Message Channel, the Coupon Channel and the Payment Channel. It should be noted that the Custom channels 56 would change, dependent upon the advertiser's 34 custom requirements and the demographic criteria of the user of the pager 2, described hereinafter.

The different categories described above are referred to as capcodes. The capcodes are presented to the user as menu selections. One embodiment of the capcodes and menu selections of the present invention is illustrated below:

| Capcode | Menu Option |
|---|---|
| 1 | Primary |
| 2 | Main Maildrop |
| 3 | News |
| 4 | Sport |
| 5 | Info 1 |
| 6 | Info 2 |
| 7 | Info 3 |
| 8 | Info 4 |
| 9 | Info 5 |
| 10 | |
| 11 | |
| 12 | |
| 13 | |
| 14 | |
| 15 | |
| 16 | |

Individual pager 2 Maildrop Message Channels may be programmed over the air (OTA) via an identification. After a user has purchased the pager 2, the pager 2 is activated. This activation may be done via the Internet or over the telephone. When activating the pager 2, the user supplies personal demographic information, such as age, gender, and/or profession. The personal demographic information is utilized to assemble the identification of the data that may be transmitted to the various capcodes. This identification is transmitted OTA to the pager 2, thereby programming the Custom channels 56 to receive Maildrop messages intended for members of a sub-set of users that an advertiser 34 wishes to contact.

When the advertiser 34 wishes to contact a sub-set of users, a request is received from the advertiser 34 for placement of a select Maildrop message 26 on the sub-set of users. Confirmation of the receipt of the request is transmitted back to the advertiser. The request comprises the requisite demographic criterion of the sub-set of users thereby allowing identification of the capcodes corresponding to the demographic criterion received from the advertiser 34. In a further embodiment, the request comprises a plurality of different demographic criterion for selecting the sub-set. A page signal is then transmitted such that the wireless devices 2 of the sub-set receive the page signal comprising the selected Maildrop message 26. When the controller 10 receives a page signal comprising the selected Maildrop message 26 received by the receiver, the controller 10 sends a signal to the alarm for notifying to the user that a page has taken place. The controller 10 further sends to the display driver a signal for causing the display 6 to display an identification of the channel from wherein the Maildrop message 26 can be accessed. The Maildrop message 26 is stored in the appropriate channel location in the Maildrop message memory 17 and can be accessed in the manner described above.

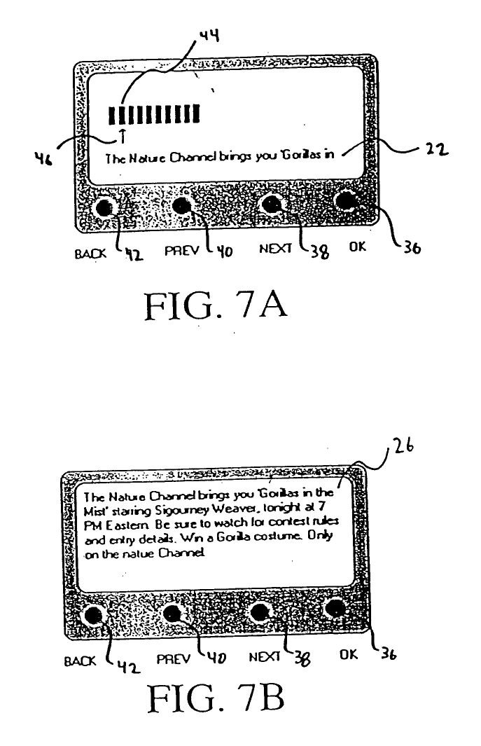

In a further embodiment of the present invention, an individual Maildrop Message Channel, such as the Custom Channel 56 may be programmed with the name of a selected advertiser as seen in FIG. 6E. In such circumstances, this Private Channel is reserved for messages originating from a select Private Channel sponsor and allows the Private Channel sponsor to have constant communication with the user of the pager 2. In this manner, it is possible for the Private Channel sponsor to advertise to a select group of users at any time. FIG. 6A-FIG. 6E and FIG. 7A-FIG. 7B display the method utilized to read a Maildrop message stored in the Maildrop message memory 17 via Maildrop Folder 48. The access and presentation of the Maildrop message from the Maildrop message memory 17 is similar to the access of the personal message from the personal messages memory 15. In order to view the Maildrop message, the user selects the Maildrop Folder 48 from the Main Menu 33 by depressing the “OK” button 36 as seen in FIG. 6A. In response, the pager 2 displays a screen as seen in FIG. 6B-FIG. 6E allowing the user to access the plurality of Maildrop Message Channels. The user may utilize the “RIGHT” button 60 and the “LEFT” button 62 to navigate the cursor 46 through the full range of Maildrop Message Channels. To assist the user in selecting a Maildrop Message Channel, the screen additionally displays, above the message channel indicators 50,52,54,56, the title of the selected Maildrop Message Channel. Depressing the “OK” button 58 displays the selected Channel on a new screen as seen in FIG. 7A.

FIG. 7A and FIG. 7B show one embodiment of a method of presenting a Maildrop message to a user. The display 6, as seen in FIG. 7A, shows the individual Maildrop messages stored in the Maildrop Message Channel 56 of FIG. 6E. Using the “NEXT” button 38 and the “PREV” button 40, the user can navigate the cursor 46 through the full range of indicators 44. To assist the user in selecting messages, the screen additionally displays, below the indicators 44, a single line of text 22 detailing the beginning of the relevant Maildrop message indicated. This allows the user to glance at the first part of the message stored in the Maildrop message memory 17 and scroll from slot to slot to find a selected message of interest. Depressing the “OK” Button 36 allows the user to display the selected message 26 on the display 6, as seen in FIG. 7B. FIG. 7B shows a selected message stored in the Maildrop messages memory 17 being displayed on the display 6 of the pager 2. Upon the selected message 26 being displayed, the functionality of the “NEXT” button 38 and “PREV” button 40 change so that depressing the NEXT button 38 moves the display screen forward so as to show subsequent screens of the message 26. When the end of the current message 26 is reached, a depression of the NEXT button 38 displays the first screen of the next message in that direction. Similarly, depressing the PREV button 40 moves the display screen backwards in the current message 26 until the beginning of the current message. When the beginning of the current message 26 is a reached, depressing PREV button 40 will display the first screen of the message in the previous direction. Depressing the BACK button 42 moves the user up a level in the menu system as seen in FIG. 7A, thereby permitting navigation through the full range of messages and selection of individual messages to be viewed.

Priority Messages

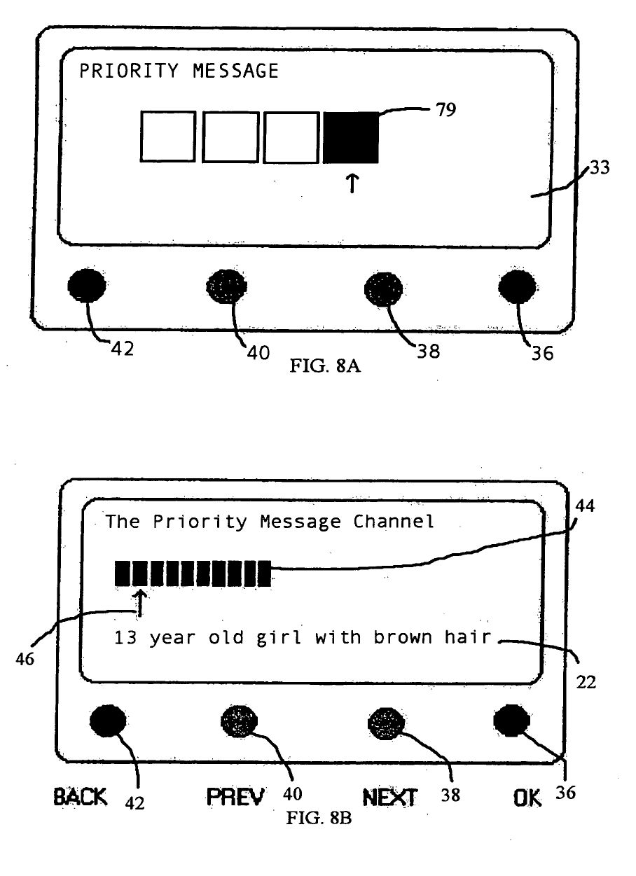

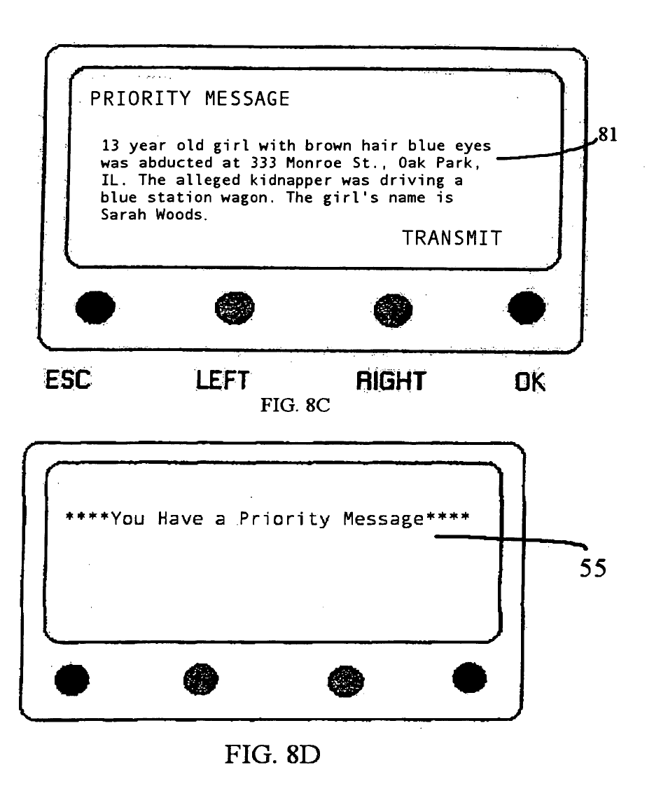

As noted above, the pager 2 includes a plurality of channels including a Priority Message Channel 79 shown in FIG. 8A. The Priority Message Channel 79 may provide a Priority Message Graphic 55 and/or a priority message to a user of a wireless device 2. The Priority Message Graphic 55 may present a graphic image prior to presentation of a received message. This Priority Message Graphic 55 can precede paging messages with an advertising logo, sponsor message, text message or the like.

In one embodiment of the present invention, the Priority Message Graphic 55 can be a text message as shown in FIG. 8D. Regardless of the user's configuration of the pager 2, a priority message(s) will override any and all other display features in order to notify of, and present to, an end user a priority message. When the memory stores an unread priority message, any user interface activity (pressing any button) will bring up the Priority Message Graphic 55, and then automatically present the user with the at least one priority message. During the period between the receipt of a priority message and the actual displaying of it, the pager will receive and function normally; however, the pager will display the priority message(s) first, regardless of the amount of received messages in the interim. After the wireless unit 2 displays the at least one priority message, the Priority Message Graphic 55 resets itself, and the pager 2 returns to ‘normal’ operation. In the event that more than one unread priority message is stored on the wireless device 2, all unread priority messages will be displayed before returning to ‘normal’ operation. Normal operation is when the user can receive a message, send a message or perform any activity without the pager 2 displaying a priority message. An example of a priority message would be in conjunction with the ‘Amber Alert’ system described hereinafter.

In another embodiment of the present invention, sellers distribute wireless units 2 to users within a given geographical area. This geographical area may be a nationwide area, a regional area, a local area, a rural area, and a metropolitan area. The wireless units 2 use a common network address and tie to it the advertisement programming already existing in the wireless units 2. The wireless units 2 designate the network address as a priority override channel and graphic software is loaded to display “AMBER ALERT” when the network address receives a priority message. Other graphics can be displayed as well. Using a common network address in all units ensures rapid deployment of the information, and sends information only once, simultaneously to wireless units 2 in the broadcast area. In addition, the alert may be transmitted to selected network addresses within the given geographical area.

Local law enforcement authorities declare an ‘Amber Alert’ regarding an abducted child. Local law enforcement authorities may include the police, the fire department, hospitals and things of the sort. Other authorities may include advertisers, companies, or other entities that have the authority to request the transmission of a priority message. Any information, which may include a description of the abductor, the vehicle the abductor used, the location and time of the abduction, the authorities collect and format for transmission. Other information such as advertisements or other sorts of messages may be collected and formatted as well. The local authorities transmit the ‘Amber Alert’ information to the central station. The central station translates and broadcasts the information to the special Priority Channel addresses in the wireless units 2. The central station can consist of any computer, hardware, software or electronic device or any combination thereof that can receive, translate and transmit a priority message.

In one embodiment, the central station can pick up the telephone and receive a priority message via telephone from an authority. The central station can then use software to assign a priority identifier to the priority message. The central station can then transmit the priority message to the plurality of wireless devices 2 via software.

In one embodiment, the central station can receive a priority message via email from an authority. The central station can then use software to assign a priority identifier to the priority message. The central station can then transmit the priority message to the plurality of wireless devices 2 via software.

In one embodiment, the central station can receive a priority message via an electronic signal from an authority. The central station can then use software to assign a priority identifier to the priority message. The central station can then transmit the priority message to the plurality of wireless devices 2 via software.

In one embodiment, the central station can receive a priority message via software from an authority. The central station can then use software to assign a priority identifier to the priority message. The central station can then transmit the priority message to the plurality of wireless devices 2 via software.

In one embodiment, the central station can receive a priority message via hardware from an authority. The central station can then use software to assign a priority identifier to the priority message. The central station can then transmit the priority message to the plurality of wireless devices 2 via software.

In one embodiment, the central station can pick up the telephone and receive a priority message via telephone from an authority. The central station can then use hardware to assign a priority identifier to the priority message. The central station can then transmit the priority message to the plurality of wireless devices 2 via software.

In one embodiment, the central station can pick up the telephone and receive a priority message via telephone from an authority. The central station can then use electronics to assign a priority identifier to the priority message. The central station can then transmit the priority message to the plurality of wireless devices 2 via software.

In one embodiment, the central station can pick up the telephone and receive a priority message via telephone from an authority. The central station can then use an automated system to assign a priority identifier to the priority message. The central station can then transmit the priority message to the plurality of wireless devices 2 via software.

In one embodiment, the central station can pick up the telephone and receive a priority message via telephone from an authority. The central station can then use software to assign a priority identifier to the priority message. The central station can then transmit the priority message to the plurality of wireless devices 2 via hardware.

In one embodiment, the central station can pick up the telephone and receive a priority message via telephone from an authority. The central station can then use software to assign a priority identifier to the priority message. The central station can then transmit the priority message to the plurality of wireless devices 2 via an automated system.

In one embodiment, the central station can pick up the telephone and receive a priority message via telephone from an authority. The central station can then use software to assign a priority identifier to the priority message. The central station can then transmit the priority message to the plurality of wireless devices 2 via an electronic signal.

In one embodiment, the central station can pick up the telephone and receive a priority message via telephone from an authority. The central station can then use hardware to assign a priority identifier to the priority message. The central station can then transmit the priority message to the plurality of wireless devices 2 via an electronic signal.

In one embodiment, the central station can pick up the telephone and receive a priority message via telephone from an authority. The central station can then use hardware to assign a priority identifier to the priority message. The central station can then transmit the priority message to the plurality of wireless devices 2 via an automated system.

In one embodiment, the central station can pick up the telephone and receive a priority message via telephone from an authority. The central station can then use hardware to assign a priority identifier to the priority message. The central station can then transmit the priority message to the plurality of wireless devices 2 via hardware.

In one embodiment, the central station can pick up the telephone and receive a priority message via telephone from an authority. The central station can then use electronics to assign a priority identifier to the priority message. The central station can then transmit the priority message to the plurality of wireless devices 2 via an electronic signal.

In one embodiment, the central station can pick up the telephone and receive a priority message via telephone from an authority. The central station can then use electronics to assign a priority identifier to the priority message. The central station can then transmit the priority message to the plurality of wireless devices 2 via an automated system.

In one embodiment, the central station can pick up the telephone and receive a priority message via telephone from an authority. The central station can then use electronics to assign a priority identifier to the priority message. The central station can then transmit the priority message to the plurality of wireless devices 2 via hardware.

In one embodiment, the central station can pick up the telephone and receive a priority message via telephone from an authority. The central station can then use an automated system to assign a priority identifier to the priority message. The central station can then transmit the priority message to the plurality of wireless devices 2 via hardware.

In one embodiment, the central station can pick up the telephone and receive a priority message via telephone from an authority. The central station can then use an automated system to assign a priority identifier to the priority message. The central station can then transmit the priority message to the plurality of wireless devices 2 via an automated system.

In one embodiment, the central station can pick up the telephone and receive a priority message via telephone from an authority. The central station can then use an automated system to assign a priority identifier to the priority message. The central station can then transmit the priority message to the plurality of wireless devices 2 via an electronic signal.

In one embodiment, the central station can receive a priority message via email from an authority. The central station can then use hardware to assign a priority identifier to the priority message. The central station can then transmit the priority message to the plurality of wireless devices 2 via software.

In one embodiment, the central station can receive a priority message via email from an authority. The central station can then use electronics to assign a priority identifier to the priority message. The central station can then transmit the priority message to the plurality of wireless devices 2 via software.

In one embodiment, the central station can receive a priority message via email from an authority. The central station can then use an automated system to assign a priority identifier to the priority message. The central station can then transmit the priority message to the plurality of wireless devices 2 via software.

In one embodiment, the central station can receive a priority message via email from an authority. The central station can then use software to assign a priority identifier to the priority message. The central station can then transmit the priority message to the plurality of wireless devices 2 via hardware.

In one embodiment, the central station can receive a priority message via email from an authority. The central station can then use software to assign a priority identifier to the priority message. The central station can then transmit the priority message to the plurality of wireless devices 2 via an automated system.

In one embodiment, the central station can receive a priority message via email from an authority. The central station can then use software to assign a priority identifier to the priority message. The central station can then transmit the priority message to the plurality of wireless devices 2 via an electronic signal.

In one embodiment, the central station can receive a priority message via email from an authority. The central station can then use hardware to assign a priority identifier to the priority message. The central station can then transmit the priority message to the plurality of wireless devices 2 via an electronic signal.

In one embodiment, the central station can receive a priority message via email from an authority. The central station can then use hardware to assign a priority identifier to the priority message. The central station can then transmit the priority message to the plurality of wireless devices 2 via an automated system.

In one embodiment, the central station can receive a priority message via email from an authority. The central station can then use hardware to assign a priority identifier to the priority message. The central station can then transmit the priority message to the plurality of wireless devices 2 via hardware.

In one embodiment, the central station can receive a priority message via email from an authority. The central station can then use electronics to assign a priority identifier to the priority message. The central station can then transmit the priority message to the plurality of wireless devices 2 via an electronic signal.

In one embodiment, the central station can receive a priority message via email from an authority. The central station can then use electronics to assign a priority identifier to the priority message. The central station can then transmit the priority message to the plurality of wireless devices 2 via an automated system.

In one embodiment, the central station can receive a priority message via email from an authority. The central station can then use electronics to assign a priority identifier to the priority message. The central station can then transmit the priority message to the plurality of wireless devices 2 via hardware.

In one embodiment, the central station can receive a priority message via email from an authority. The central station can then use an automated system to assign a priority identifier to the priority message. The central station can then transmit the priority message to the plurality of wireless devices 2 via hardware.

In one embodiment, the central station can receive a priority message via email from an authority. The central station can then use an automated system to assign a priority identifier to the priority message. The central station can then transmit the priority message to the plurality of wireless devices 2 via an automated system.

In one embodiment, the central station can receive a priority message via email from an authority. The central station can then use an automated system to assign a priority identifier to the priority message. The central station can then transmit the priority message to the plurality of wireless devices 2 via an electronic signal.

In one embodiment, the central station can receive a priority message via an electronic signal from an authority. The central station can then use hardware to assign a priority identifier to the priority message. The central station can then transmit the priority message to the plurality of wireless devices 2 via software.

In one embodiment, the central station can receive a priority message via an electronic signal from an authority. The central station can then use electronics to assign a priority identifier to the priority message. The central station can then transmit the priority message to the plurality of wireless devices 2 via software.

In one embodiment, the central station can receive a priority message via an electronic signal from an authority. The central station can then use an automated system to assign a priority identifier to the priority message. The central station can then transmit the priority message to the plurality of wireless devices 2 via software.

In one embodiment, the central station can receive a priority message via an electronic signal from an authority. The central station can then use software to assign a priority identifier to the priority message. The central station can then transmit the priority message to the plurality of wireless devices 2 via hardware.

In one embodiment, the central station can receive a priority message via an electronic signal from an authority. The central station can then use software to assign a priority identifier to the priority message. The central station can then transmit the priority message to the plurality of wireless devices 2 via an automated system.

In one embodiment, the central station can receive a priority message via an electronic signal from an authority. The central station can then use software to assign a priority identifier to the priority message. The central station can then transmit the priority message to the plurality of wireless devices 2 via an electronic signal.

In one embodiment, the central station can receive a priority message via an electronic signal from an authority. The central station can then use hardware to assign a priority identifier to the priority message. The central station can then transmit the priority message to the plurality of wireless devices 2 via an electronic signal.

In one embodiment, the central station can receive a priority message via an electronic signal from an authority. The central station can then use hardware to assign a priority identifier to the priority message. The central station can then transmit the priority message to the plurality of wireless devices 2 via an automated system.

In one embodiment, the central station can receive a priority message via an electronic signal from an authority. The central station can then use hardware to assign a priority identifier to the priority message. The central station can then transmit the priority message to the plurality of wireless devices 2 via hardware.

In one embodiment, the central station can receive a priority message via an electronic signal from an authority. The central station can then use electronics to assign a priority identifier to the priority message. The central station can then transmit the priority message to the plurality of wireless devices 2 via an electronic signal.

In one embodiment, the central station can receive a priority message via an electronic signal from an authority. The central station can then use electronics to assign a priority identifier to the priority message. The central station can then transmit the priority message to the plurality of wireless devices 2 via an automated system.

In one embodiment, the central station can receive a priority message via an electronic signal from an authority. The central station can then use electronics to assign a priority identifier to the priority message. The central station can then transmit the priority message to the plurality of wireless devices 2 via hardware.

In one embodiment, the central station can receive a priority message via an electronic signal from an authority. The central station can then use an automated system to assign a priority identifier to the priority message. The central station can then transmit the priority message to the plurality of wireless devices 2 via hardware.

In one embodiment, the central station can receive a priority message via an electronic signal from an authority. The central station can then use an automated system to assign a priority identifier to the priority message. The central station can then transmit the priority message to the plurality of wireless devices 2 via an automated system.

In one embodiment, the central station can receive a priority message via an electronic signal from an authority. The central station can then use an automated system to assign a priority identifier to the priority message. The central station can then transmit the priority message to the plurality of wireless devices 2 via an electronic signal.

In one embodiment, the central station can receive a priority message via software from an authority. The central station can then use hardware to assign a priority identifier to the priority message. The central station can then transmit the priority message to the plurality of wireless devices 2 via software.

In one embodiment, the central station can receive a priority message via software from an authority. The central station can then use electronics to assign a priority identifier to the priority message. The central station can then transmit the priority message to the plurality of wireless devices 2 via software.

In one embodiment, the central station can receive a priority message via software from an authority. The central station can then use an automated system to assign a priority identifier to the priority message. The central station can then transmit the priority message to the plurality of wireless devices 2 via software.

In one embodiment, the central station can receive a priority message via software from an authority. The central station can then use software to assign a priority identifier to the priority message. The central station can then transmit the priority message to the plurality of wireless devices 2 via hardware.

In one embodiment, the central station can receive a priority message via software from an authority. The central station can then use software to assign a priority identifier to the priority message. The central station can then transmit the priority message to the plurality of wireless devices 2 via an automated system.

In one embodiment, the central station can receive a priority message via software from an authority. The central station can then use software to assign a priority identifier to the priority message. The central station can then transmit the priority message to the plurality of wireless devices 2 via an electronic signal.

In one embodiment, the central station can receive a priority message via software from an authority. The central station can then use hardware to assign a priority identifier to the priority message. The central station can then transmit the priority message to the plurality of wireless devices 2 via an electronic signal.

In one embodiment, the central station can receive a priority message via software from an authority. The central station can then use hardware to assign a priority identifier to the priority message. The central station can then transmit the priority message to the plurality of wireless devices 2 via an automated system.

In one embodiment, the central station can receive a priority message via software from an authority. The central station can then use hardware to assign a priority identifier to the priority message. The central station can then transmit the priority message to the plurality of wireless devices 2 via hardware.

In one embodiment, the central station can receive a priority message via software from an authority. The central station can then use electronics to assign a priority identifier to the priority message. The central station can then transmit the priority message to the plurality of wireless devices 2 via an electronic signal.

In one embodiment, the central station can receive a priority message via software from an authority. The central station can then use electronics to assign a priority identifier to the priority message. The central station can then transmit the priority message to the plurality of wireless devices 2 via an automated system.

In one embodiment, the central station can receive a priority message via software from an authority. The central station can then use electronics to assign a priority identifier to the priority message. The central station can then transmit the priority message to the plurality of wireless devices 2 via hardware.

In one embodiment, the central station can receive a priority message via software from an authority. The central station can then use an automated system to assign a priority identifier to the priority message. The central station can then transmit the priority message to the plurality of wireless devices 2 via hardware.

In one embodiment, the central station can receive a priority message via software from an authority. The central station can then use an automated system to assign a priority identifier to the priority message. The central station can then transmit the priority message to the plurality of wireless devices 2 via an automated system.

In one embodiment, the central station can receive a priority message via software from an authority. The central station can then use an automated system to assign a priority identifier to the priority message. The central station can then transmit the priority message to the plurality of wireless devices 2 via an electronic signal.

In one embodiment, the central station can receive a priority message via hardware from an authority. The central station can then use hardware to assign a priority identifier to the priority message. The central station can then transmit the priority message to the plurality of wireless devices 2 via software.

In one embodiment, the central station can receive a priority message via hardware from an authority. The central station can then use electronics to assign a priority identifier to the priority message. The central station can then transmit the priority message to the plurality of wireless devices 2 via software.

In one embodiment, the central station can receive a priority message via hardware from an authority. The central station can then use an automated system to assign a priority identifier to the priority message. The central station can then transmit the priority message to the plurality of wireless devices 2 via software.

In one embodiment, the central station can receive a priority message via hardware from an authority. The central station can then use software to assign a priority identifier to the priority message. The central station can then transmit the priority message to the plurality of wireless devices 2 via hardware.

In one embodiment, the central station can receive a priority message via hardware from an authority. The central station can then use software to assign a priority identifier to the priority message. The central station can then transmit the priority message to the plurality of wireless devices 2 via an automated system.

In one embodiment, the central station can receive a priority message via hardware from an authority. The central station can then use software to assign a priority identifier to the priority message. The central station can then transmit the priority message to the plurality of wireless devices 2 via an electronic signal.

In one embodiment, the central station can receive a priority message via hardware from an authority. The central station can then use hardware to assign a priority identifier to the priority message. The central station can then transmit the priority message to the plurality of wireless devices 2 via an electronic signal.

In one embodiment, the central station can receive a priority message via hardware from an authority. The central station can then use hardware to assign a priority identifier to the priority message. The central station can then transmit the priority message to the plurality of wireless devices 2 via an automated system.

In one embodiment, the central station can receive a priority message via hardware from an authority. The central station can then use hardware to assign a priority identifier to the priority message. The central station can then transmit the priority message to the plurality of wireless devices 2 via hardware.

In one embodiment, the central station can receive a priority message via hardware from an authority. The central station can then use electronics to assign a priority identifier to the priority message. The central station can then transmit the priority message to the plurality of wireless devices 2 via an electronic signal.

In one embodiment, the central station can receive a priority message via hardware from an authority. The central station can then use electronics to assign a priority identifier to the priority message. The central station can then transmit the priority message to the plurality of wireless devices 2 via an automated system.

In one embodiment, the central station can receive a priority message via hardware from an authority. The central station can then use electronics to assign a priority identifier to the priority message. The central station can then transmit the priority message to the plurality of wireless devices 2 via hardware.

In one embodiment, the central station can receive a priority message via hardware from an authority. The central station can then use an automated system to assign a priority identifier to the priority message. The central station can then transmit the priority message to the plurality of wireless devices 2 via hardware.

In one embodiment, the central station can receive a priority message via hardware from an authority. The central station can then use an automated system to assign a priority identifier to the priority message. The central station can then transmit the priority message to the plurality of wireless devices 2 via an automated system.

In one embodiment, the central station can receive a priority message via hardware from an authority. The central station can then use an automated system to assign a priority identifier to the priority message. The central station can then transmit the priority message to the plurality of wireless devices 2 via an electronic signal.

The pager 2 responds by alerting the user and storing the Amber information as a priority message. This priority message as described above will override any and all other display features, and if unread, the Priority Message Graphic 55 will come up upon any user interface activity. After a user views a priority message, the message is stored in the Priority Message memory 84.

As mentioned above, the pager 2 includes a Priority Message Channel 79 having Priority Messages that can be accessed similar to accessing advertising messages in the Maildrop Message Channel via the main menu 33. The received Priority Messages are stored in a Priority Message memory 84 and is accessed via the interface through the Priority Message Channel 79 as seen in FIG. 8A. Selecting the Priority Message Channel 79 opens a new menu screen presenting a plurality of priority messages stored in the Priority Message Channel 79 as seen in FIG. 8B. Using the “NEXT” button 38 and the “PREV” button 40, the user can navigate the cursor 46 through the full range of indicators 44. To assist the user in selecting a priority message, the screen additionally displays, below the indicators 44, a single line of text 22 detailing the beginning of the relevant priority message indicated. This allows the user to glance at the first part of the priority message stored in the Priority Message memory 84 and scroll from slot to slot to find a selected priority message of interest. Depressing the “OK” button 36 allows the user to display the selected priority message 81 on the display 6, as seen in FIG. 8C.

FIG. 8C shows a selected priority message 81 stored in the Priority Message memory 84 being displayed on the display 6 of the wireless unit 2. Upon the selected priority message 81 being displayed, the functionality of the “NEXT” button 38 and “PREV” button 40 change so that depressing the “NEXT” button 38 moves the display screen forward so as to show subsequent screens of the priority message. When the end of the selected priority message 81 is reached, a depression of the “NEXT” button 38 displays the first screen of the next priority message in that direction. Similarly, depressing the “PREV” button 40 moves the display screen backwards in the selected priority message 81 until the beginning of the selected priority message 81. When the beginning of the selected priority message 81 is reached, depressing the “PREV” button 40 will display the first screen of the priority message in the previous direction. Depressing the “BACK” button 42 moves the user up a level in the menu system as seen in FIG. 8B, thus allowing navigation through the full range of priority messages and selection of individual priority messages to be viewed.

While the specific embodiments have been illustrated and described, numerous modifications come to mind without significantly departing from the spirit of the invention and the scope of protection is only limited by the scope of the accompanying claims.

What is claimed is:

1. A method for providing priority messages to a plurality of wireless devices for notifying respective users of the wireless devices of the priority message, the method comprising the steps of:
providing for receiving a priority message from an authority;
providing for assigning a priority identifier to the priority message;
providing for transmitting the priority message to the plurality of wireless devices, wherein the priority identifier will cause the priority message to receive priority status once received by the plurality of the wireless devices.

2. The method of claim 1 further comprising the step of:
providing for displaying the priority message on the display of the plurality of wireless devices before any other message is displayed on the display of the plurality of wireless device.

3. The method of claim 1, wherein the priority identifier comprises a network address.

4. The method of claim 1 further comprising the step of:
providing for assigning the priority message to a priority channel within the plurality of wireless devices.

5. The method of claim 4 further comprising the step of:
providing for displaying the priority message received on the priority channel of the plurality of wireless devices, on the display of the plurality of wireless devices immediately upon receipt by the plurality of wireless devices.

6. The method of claim 1 further comprising the step of:
providing for storing the priority message received on the priority channel of the plurality of wireless devices, in a priority state within the plurality of wireless devices.

7. The method of claim 1, wherein the wireless devices tracks whether priority message has been displayed on the display of the wireless device.

8. The method of claim 1 further comprising the step of:
providing for storing the priority message in a memory of the plurality of wireless devices for later retrieval, once the priority message has been displayed on the display of the plurality of wireless devices.

9. The method of claim 1, wherein the authority comprises at least of one of a local law enforcement authority and an advertiser that has the authority to request the transmission of the priority message.

10. The method of claim 1 further comprising the step of:
providing for automatically displaying the priority message upon any activity of a user interface of the plurality of wireless devices.

11. The method of claim 1 further comprising the step of:
providing for automatically displaying a graphic on the display of the plurality of wireless devices prior to displaying the priority message.

12. The method of claim 1 further comprising the step of:
providing for automatically displaying a graphic on the display of the plurality of wireless devices after displaying the priority message.

13. The method of claim 12, wherein the graphic is an advertising logo.

14. The method of claim 12, wherein the graphic is a sponsor message.

15. The method of claim 1 further comprising the step of:
providing for distributing the plurality of wireless devices within a geographical area.

16. The method of claim 15, wherein the geographical area comprises at least one of a nationwide area, a regional area, a local area, a rural area, and a metropolitan area.

17. The method of claim 1, wherein step of receiving the priority message comprises receiving the priority message from an “Amber Alert” system.

18. The method of claim 1, wherein step of providing for receiving the priority message comprises the step of providing for receiving a graphic from an “Amber Alert” system.

19. The method of claim 1, wherein the priority message comprises at least one of information regarding an abductee, information regarding an abductor, information regarding a vehicle, information regarding a time, information regarding a location.

20. The method of claim 1 further comprising the step of:
providing for formatting the priority message for transmission to the plurality of wireless devices using information regarding an “Amber Alert.”

21. The method of claim 1 further comprising the step of:
providing for notifying respective users of the plurality of wireless devices of an “Amber Alert” priority message.

22. A system for providing priority messages to a plurality of wireless devices for notifying respective users of the wireless devices of the priority message, the system comprising:
means for receiving a priority message from an authority;
means for assigning a priority identifier to the priority message;
means for transmitting the priority message to the plurality of wireless devices, wherein the priority identifier will cause the priority message to receive priority status once received by the plurality of the wireless devices.

23. The system of claim 22 further comprising:
means for displaying the priority message on the display of the plurality of wireless devices before any other message is displayed on the display of the plurality of wireless device.

24. The system of claim 22, wherein the priority identifier comprises a network address.

25. The system of claim 22 further comprising:
assigning the priority message to a priority channel within the plurality of wireless devices.

26. The system of claim 22 further comprising:
displaying the priority message received on the priority channel of the plurality of wireless devices, on the display of the plurality of wireless devices immediately upon receipt by the plurality of wireless devices.

27. The system of claim 22 further comprising:
storing the priority message received on the priority channel of the plurality of wireless devices, in a priority state within the plurality of wireless devices.

28. The system of claim 22, wherein the wireless devices tracks whether priority message has been displayed on the display of the wireless device.

29. The system of claim 22 further comprising:
storing the priority message in a memory of the plurality of wireless devices for later retrieval, once the priority message has been displayed on the display of the plurality of wireless devices.

30. The system of claim 22, wherein the authority comprises at least of one of a local law enforcement authority and an advertiser that has the authority to request the transmission of the priority message.

40. The system of claim 22, further comprising:
automatically displaying the priority message upon any activity of a user interface of the plurality of wireless devices.

41. The system of claim 22, further comprising:
automatically displaying a graphic on the display of the plurality of wireless devices prior to displaying the priority message.

42. The system of claim 22, further comprising:
automatically displaying a graphic on the display of the plurality of wireless devices after displaying the priority message.

43. The system of claim 42, wherein the graphic is an advertising logo.

44. The system of claim 42, wherein the graphic is a sponsor message.

45. The system of claim 22 further comprising:
distributing the plurality of wireless devices within a geographical area.

46. The system of claim 45, wherein the geographical area comprises at least one of a nationwide area, a regional area, a local area, a rural area, and a metropolitan area.

47. The system of claim 22, wherein step of receiving the priority message comprises receiving the priority message from an “Amber Alert” system.

48. The system of claim 22, wherein step of receiving the priority message comprises receiving a graphic from an “Amber Alert” system.

49. The system of claim 22, wherein the priority message comprises at least one of information regarding an abductee, information regarding an abductor, information regarding a vehicle, information regarding a time, information regarding a location,

50. The system of claim 22 further comprising:
formatting the priority message of for transmission to the plurality of wireless devices using information regarding an “Amber Alert.”

51. The system of claim 22 further comprising:
notifying respective users of the plurality of wireless devices of an “Amber Alert” priority message.

52. A wireless device for notifying a user of the wireless device of a priority message, wireless device comprising:
a display for displaying a priority message originating from an authority; and,
a receiver for receiving the priority message, wherein a priority identifier is assigned to the priority message, and wherein the priority identifier will cause the priority message to receive priority status once received by the wireless device.

53. The device of claim 52 further comprising:
means for displaying the priority message on the display of the plurality of wireless devices before any other message is displayed on the display of the plurality of wireless device.

54. The device of claim 52, further comprising:
displaying the priority message received on the priority channel of the plurality of wireless devices, on the display of the plurality of wireless devices immediately upon receipt by the plurality of wireless devices.

55. The device of claim 52, further comprising:
automatically displaying the priority message upon any activity of a user interface of the plurality of wireless devices.
